(19) United States
(12) Patent Application Publication
(10) Pub. No.: US 2016/0145722 A1
(43) Pub. Date: May 26, 2016

(54) ALLOY CASTING MATERIAL AND METHOD FOR MANUFACTURING ALLOY OBJECT

(71) Applicant: INDUSTRIAL TECHNOLOGY RESEARCH INSTITUTE, Hsinchu (TW)

(72) Inventors: Yu-Hsien CHOU, Tainan City (TW); Chih-Chao YANG, Tainan City (TW); Yen-Yu HOU, Tainan City (TW); Chih-Jung WENG, Tainan City (TW); Chi-San CHEN, Kaohsiung City (TW)

(73) Assignee: INDUSTRIAL TECHNOLOGY RESEARCH INSTITUTE, Hsinchu (TW)

(21) Appl. No.: 14/869,198

(22) Filed: Sep. 29, 2015

(30) Foreign Application Priority Data
Nov. 21, 2014 (TW) 103140383

(51) Int. Cl. C22C 21/02; C22F 1/043; B23K 26/342

(52) U.S. Cl. CPC C22C 21/02; B23K 26/342; C22F 1/043; B33Y 10/00

(57) ABSTRACT

An alloy casting material is provided, which includes 97 to 99 parts by weight of Al and Si, 0.25 to 0.4 parts by weight of Cu, and 0.15 to 1.35 parts by weight of a combination of at least two of Mg, Ni, and Ti. The alloy casting material can be sprayed by gas to form powders, which are melted by laser-additive manufacturing to form a melted object. The melted object can be processed by an ageing heat treatment to complete an alloy object.

### CROSS REFERENCE TO RELATED APPLICATIONS

The present application is based on, and claims priority from, Taiwan Application Ser. Number 103140383, filed on Nov. 21, 2014, the disclosure of which is hereby incorporated by reference herein in its entirety.

### TECHNICAL FIELD

The technical field relates to an alloy casting material, and in particular it relates to a composition and a shaping method of the alloy casting material.

### BACKGROUND

In recent years, the cost of petroleum has risen very high, and the topics of alternative energy and environmental protection have gradually become important. Power units (e.g. turbo compressor, cylinder end, exhaust manifold, and the like) of vehicles such as cars or motorcycles made of light-weight aluminum alloy material have become a trend. The conventional power units of the aforementioned types of vehicles are usually manufactured with traditional casting method, thereby limiting the product appearance and the structural design due to the complicated post-CNC processing and heat treatment. The traditional casting method takes a long time, expends a huge amount of energy, and uses up an excessive amount of raw materials. Moreover, power units with complicated shapes are more difficult to process. The complicated processing steps and long processing period are equal to a high processing cost. Accordingly, the traditional casting method is not suitable for developing components with a complicated structure and multiple requirements in cars and motorcycles.

Accordingly, a novel aluminum alloy material and related processing method is called for for overcoming the time-consuming and labor-intensive problems with the conventional method.

### SUMMARY

One embodiment of the disclosure provides an alloy casting material, comprising: 97 to 99 parts by weight of Al and Si; 0.25 to 0.4 parts by weight of Cu; and 0.15 to 1.35 parts by weight of a combination of at least two of Mg, Ni, and Ti.

One embodiment of the disclosure provides a method of forming an alloy object, comprising: spraying the alloy casting material as claimed in claim 1 by gas to form powders; melting the powders by laser-additive manufacturing to form a melted object; and processing an ageing heat treatment for the melted object to complete the alloy object.

A detailed description is given in the following embodiments with reference to the accompanying drawings.

### DETAILED DESCRIPTION

In the following detailed description, for the purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

In the following descriptions, a power unit of a vehicle is melted by laser-additive manufacturing. Conventional three-step processes (shaping, post-CNC processing, and heat treatment) can be simplified to a single additive melting process by the laser additive melting technology. The melted object is near a net-shape of the final product, which may reduce the amount that raw materials need and solve the processing problems of the structures being difficult to process (such as power units with an internal cooling channel design). The aluminum alloy powder should have thermal resistance and mechanical strength to meet the requirement for the power unit standard of cars, motorcycles, and other vehicles. In addition, the above aluminum alloy powder should be also melted by the laser-additive manufacturing. As such, the composition of the aluminum alloy powder should be fine-tuned to enhance the mechanical strength at high temperatures of the melted object made from the aluminum alloy powder. On the other hand, the aluminum alloy bulk can be sprayed by gas to form the aluminum alloy powders with high roundness.

In one embodiment, the alloy casting powder includes 97 to 99 parts by weight of Al and Si, 0.25 to 0.4 parts by weight of Cu, and 0.15 to 1.35 parts by weight of a combination of at least two of Mg, Ni, and Ti. An overly high Cu ratio may reduce the casting flowability and corrosion resistance of the powder. An overly low Cu ratio may reduce the mechanical strength and processability of the aluminum alloy.

In one embodiment, the alloy casting material includes 6 to 8 parts by weight of Si and 89 to 93 parts by weight of Al. An overly high Si ratio may degrade the alloy elongation. An overly low Si ratio may reduce the casting flowability and the casting material hardness.

In one embodiment, the alloy casting material includes 0.7 to 0.9 parts by weight of Mg. An overly high Mg ratio may degrade the alloy elongation. An overly low Mg ratio may reduce the strength and the abrasion resistance of the aluminum alloy. In one embodiment, the alloy casting material includes 0.1 to 0.25 parts by weight of Ni. An overly high Ni ratio may degrade the alloy elongation. An overly low Ni ratio cannot enhance the mechanical properties at high temperature of the aluminum alloy. In one embodiment, the alloy casting material includes 0.05 to 0.2 parts by weight of Ti. An overly high Ti ratio may form compound with other elements in the aluminum alloy, thereby negatively influencing the mechanical properties of the alloy material.

In one embodiment, the alloy casting material can be used to form an alloy object. For example, Al, Si, Cu, Ni, Mg, and Ti of above ratios can be melted to form an alloy bulk. The alloy bulk was sprayed by gas to form powders, and the powder is then melted by laser-additive manufacturing to form a melted object. In one embodiment, the powder has a diameter of 5 μm to 35 μm. An overly large powder will make the melted object have an overly high surface roughness, thereby lowering the precision of the melted object. An overly small powder is easily aggregated to lower the flowability of the powder, thereby negatively influencing the thickness uniformity of each powder layer during the laser-additive manufacturing. In one embodiment, the melting of the laser-additive manufacturing is performed at a temperature of 660° C. to 2400° C. . An overly high melting temperature of the laser-additive manufacturing will vaporize the aluminum alloy material. An overly low melting temperature of the laser-additive manufacturing cannot melt the aluminum alloy material. Thereafter, the melted object was processed by an ageing heat treatment to complete an alloy object. In one embodiment, the ageing heat treatment is performed at a temperature of 150° C. to 180° C. . An overly high ageing heat treatment temperature will result in fewer precipitated phases with a larger diameter and a lower density due to over ageing, which may lower the hardness of the alloy object. An overly low ageing heat treatment temperature cannot sufficiently precipitate phase, thereby insufficiently improving the hardness of the alloy object. The principles of the gas spraying, the melting by laser-additive manufacturing, and the ageing heat treatment are so-called 3D printing, in which the melted alloy powder is stacked to form a shape. The 3D printing may reduce the need for raw materials which are consumed in conventional lathe processing, or omit the need for a mold in conventional mold shaping.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

Al, Si, Cu, Mg, Ni, and Ti were weighed as indicated in Table 1 and mixed, and then melted in a high temperature furnace to form aluminum alloys. The aluminum alloys were sequentially sprayed by gas to form powders, melted by laser-additive manufacturing, and processed by ageing heat treatment at 165° C. for 6 hours. The standard hardness (HRB) of the laser melted object of the aluminum alloys before and after the ageing heat treatment were analyzed by a Rockwell hardness tester on the basis of ASTM E18 standard, as shown in Table 1. The laser melted aluminum alloys were hardened by ageing precipitating, wherein the laser melted object with 0.3 and 0.4 parts by weight of Cu had the greatest increase of hardness after the ageing heat treatment.

TABLE 1

| | | | | | | | Hardness of the laser | Hardness of the laser |
|---|---|---|---|---|---|---|---|---|
| | | | | | | | melted object before | melted object after |
| Sample | | | | | | | the ageing heat | the ageing heat |
| No. | Al | Si | Cu | Ni | Mg | Ti | treatment (HRB) | treatment (HRB) |
| A1 | 91.95 | 7 | 0.2 | 0.15 | 0.7 | 0 | 23.6 | 51.2 |
| A2 | 91.65 | 7 | 0.3 | 0.15 | 0.8 | 0.1 | 32.3 | 71.5 |
| A3 | 91.35 | 7 | 0.4 | 0.15 | 0.9 | 0.2 | 35.4 | 73.1 |
| A4 | 91.6 | 7 | 0.2 | 0.2 | 0.8 | 0.2 | 18.3 | 40.9 |
| A5 | 91.6 | 7 | 0.3 | 0.2 | 0.9 | 0 | 37.7 | 75.6 |
| A6 | 91.6 | 7 | 0.4 | 0.2 | 0.7 | 0.1 | 34.1 | 73.6 |
| A7 | 91.55 | 7 | 0.2 | 0.25 | 0.9 | 0.1 | 25.6 | 57.8 |
| A8 | 91.55 | 7 | 0.3 | 0.25 | 0.7 | 0.2 | 29.7 | 70.7 |
| A9 | 91.55 | 7 | 0.4 | 0.25 | 0.8 | 0 | 35.9 | 74.3 |

The properties of samples A1-A9 were tested as indicated below: the ultimate tensile strength at room temperature of the samples was tested by Gleeble3500 on the basis of the ASTM E8 standard, the yield strength at room temperature of the samples was tested by Gleeble3500 on the basis of the ASTM E8 standard, the elongation rate at room temperature of the samples was tested by Gleeble3500 on the basis of the ASTM E8 standard, the ultimate tensile strength at high temperature of the samples was tested by Gleeble3500 on the basis of the ASTM E8 (E8M) and E21 standards, the yield strength at high temperature of the samples was tested by Gleeble3500 on the basis of the ASTM E8 (E8M) and E21 standards, and the elongation rate at high temperature of the samples was tested by Gleeble3500 on the basis of the ASTM E8 (E8M) and E21 standards, as shown in Table 2. After the ageing heat treatment, Sample A2 (Al_{91.65}Si₇Cu_{0.3}Mg_{0.8}Ni_{0.15}Ti_{0.1}) and Sample A8 (Al_{91.55}Si₇Cu_{0.3}Mg_{0.7}Ni_{0.25}Ti_{0.2}) simultaneously met the requirements for mechanical strength and elongation rate at room temperature and high temperature (250° C)..

TABLE 2

| | Ultimate tensile | Yield strength | Elongation | Ultimate tensile | Yield strength | Elongation |
|---|---|---|---|---|---|---|
| Sample | strength at room | at room | rate at room | strength at high | at high | rate at high |
| No. | temperature | temperature | temperature | temperature | temperature | temperature |
| A1 | 267 MPa | 185 MPa | 5.1% | 142 MPa | 130 MPa | 11.8% |
| A2 | 355 MPa | 232 MPa | 3.9% | 238 MPa | 194 MPa | 5.2% |
| A3 | 338 MPa | 219 MPa | 2% | 222 MPa | 185 MPa | 4.3% |
| A4 | 251 MPa | 172 MPa | 7.5% | 125 MPa | 106 MPa | 13.7% |
| A5 | 348 MPa | 224 MPa | 2.5% | 234 MPa | 193 MPa | 4.8% |
| A6 | 339 MPa | 218 MPa | 2.1% | 227 MPa | 183 MPa | 3.5% |
| A7 | 291 MPa | 186 MPa | 5.3% | 162 MPa | 142 MPa | 7.5% |
| A8 | 340 MPa | 206 MPa | 4% | 227 MPa | 188 MPa | 5.1% |
| A9 | 334 MPa | 201 MPa | 2.2% | 218 MPa | 183 MPa | 4.8% |

### Example 2

Si, Mg, Ni, and Ti contents were fixed and Al and Cu contents were changed as shown in Table 3. The above elements were mixed and melted to form aluminum alloys. The aluminum alloys were sequentially sprayed by inert gas to form powders, melted by laser-additive manufacturing, and processed by ageing heat treatment at 165° C. for 6 hours. The standard hardness (HRB) of the laser melted object of the aluminum alloys before and after the ageing heat treatment are shown in Table 4. The ultimate tensile strength at room temperature, the yield strength at room temperature, the elongation rate at room temperature, the ultimate tensile strength at high temperature, the yield strength at high temperature, and the elongation rate at high temperature of the samples B1-B4 are shown in Table 5. The above properties of Samples B1-B4 were tested on the basis as described above. Sample B3 (Al_{91.5}Si₇Cu_{0.3}Mg_{0.8}Ni_{0.2}Ti_{0.2}) after the ageing heat treatment simultaneously had a hardness (HRB) of 74.5 and simultaneously met the requirement of the mechanical strength and elongation rate at room temperature and high temperature (250° C).

TABLE 3

| | | | | | | | Hardness of the laser | Hardness of the laser |
|---|---|---|---|---|---|---|---|---|
| | | | | | | | melted object before | melted object after |
| Sample | | | | | | | the ageing heat | the ageing heat |
| No. | Al | Si | Cu | Ni | Mg | Ti | treatment (HRB) | treatment (HRB) |
| B1 | 91.6 | 7 | 0.2 | 0.2 | 0.8 | 0.2 | 18.3 | 40.9 |
| B2 | 91.55 | 7 | 0.25 | 0.2 | 0.8 | 0.2 | 33.3 | 67.2 |
| B3 | 91.5 | 7 | 0.3 | 0.2 | 0.8 | 0.2 | 38.4 | 74.5 |
| B4 | 91.45 | 7 | 0.35 | 0.2 | 0.8 | 0.2 | 37.3 | 74.9 |

TABLE 4

| | Ultimate tensile | Yield strength | Elongation rate | Ultimate tensile | Yield strength | Elongation |
|---|---|---|---|---|---|---|
| Sample | strength at room | at room | at room | strength at high | at high | rate at high |
| No. | temperature | temperature | temperature | temperature | temperature | temperature |
| B1 | 251 MPa | 172 MPa | 7.5% | 125 MPa | 106 MPa | 13.7% |
| B2 | 312 MPa | 211 MPa | 4.3% | 198 MPa | 164 MPa | 6.2% |
| B3 | 357 MPa | 235 MPa | 3.8% | 242 MPa | 199 MPa | 4.9% |
| B4 | 354 MPa | 241 MPa | 2.6% | 225 MPa | 189 MPa | 3.9% |

### Comparative Example 1

Commercially available aluminum alloy AlSi10Mg (A360, commercially available from Jen-Yu Cooperation, Taiwan) and AlSi₉Fe_{1.2}Cu₄Mn_{0.5}Mg_{1.0}Ni_{0.5}Zn_{1.0}Ti_{0.25} (AC4B, commercially available from Jen-Yu Cooperation, Taiwan) were selected to be sprayed by gas to form powders, melted by laser-additive manufacturing, and processed by ageing heat treatment at 165° C. for 6 hours, too. The mechanical strengths at room temperature and high temperature of the products were tested and compared, as shown in Table 5. The alloy objects made from the aluminum alloy powder of the disclosure had a higher ultimate tensile strength (UTS) and yield strength (YS) at high temperature (250° C). than that of the alloy objects made from the commercially available aluminum alloy materials. In other words, the alloy objects made from the aluminum alloy powder of the disclosure is more suitable to be applied in power units of the car or motorcycle industry.

TABLE 5

| | | | A1-A9 and B1-B4 |
|---|---|---|---|
| Compositions | AlSi10Mg | AC4B | samples |
| Strength at room | YS: 220 MPa | YS: 220 MPa | YS > 220 MPa |
| temperature | UTS: 325 MPa | UTS: 320 MPa | UTS > 350 MPa |
| Strength at high | YS: 50 MPa | YS: 75 MPa | YS > 180 MPa |
| temperature | UTS: 85 MPa | UTS: 110 MPa | UTS > 220 MPa |
| (250° C.) | | | |

### Comparative Example 2

Aluminum alloy materials with element ranges out of that in the disclosure (see Table 6) were selected, and then sprayed by gas to form powders, melted by laser-additive manufacturing, and processed by ageing heat treatment at 165° C. for 6 hours, too. The mechanical strengths at room temperature and high temperature of the products were tested and compared, as shown in Table 7. The alloy objects made from the aluminum alloy powder of the disclosure had a higher ultimate tensile strength (UTS) and yield strength (YS) at high temperature (250° C.) than that of the alloy objects made from the four aluminum alloy materials in Table 6. In other words, the alloy objects made from the aluminum alloy powder of the disclosure is more suitable to be applied in power units of the car or motorcycle industry.

TABLE 6

| Sample | | | | | | |
|---|---|---|---|---|---|---|
| No. | Al | Si | Cu | Ni | Mg | Ti |
| C1 | 89.8 | 6 | 3.5 | 0.35 | 0.1 | 0.25 |
| C2 | 87.15 | 8.5 | 3 | 0.5 | 0.6 | 0.25 |
| C3 | 84.25 | 11 | 1 | 2.5 | 1 | 0.25 |
| C4 | 92.05 | 5 | 1.2 | 1 | 0.5 | 0.25 |

TABLE 7

| | Ultimate tensile | Yield strength | Elongation | Ultimate tensile | Yield strength | Elongation |
|---|---|---|---|---|---|---|
| Sample | strength at room | at room | rate at room | strength at high | at high | rate at high |
| No. | temperature | temperature | temperature | temperature | temperature | temperature |
| C1 | 250 MPa | 165 MPa | 2% | 110 MPa | 65 MPa | 8% |
| C2 | 248 MPa | 193 MPa | 1% | 130 MPa | 83 MPa | 6% |
| C3 | 250 MPa | 195 MPa | 0.5% | 125 MPa | 70 MPa | 5% |
| C4 | 240 MPa | 170 MPa | 3% | 65 MPa | 35 MPa | 16% |

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. An alloy casting material, comprising:
97 to 99 parts by weight of Al and Si;
0.25 to 0.4 parts by weight of Cu; and
0.15 to 1.35 parts by weight of a combination of at least two of Mg, Ni, and Ti.

2. The alloy casting material as claimed in claim 1, including 6 to 8 parts by weight of Si.

3. The alloy casting material as claimed in claim 1, including 89 to 93 parts by weight of Al.

4. The alloy casting material as claimed in claim 1, including 0.7 to 0.9 parts by weight of Mg.

5. The alloy casting material as claimed in claim 1, including 0.1 to 0.25 parts by weight of Ni.

6. The alloy casting material as claimed in claim 1, including 0.05 to 0.2 parts by weight of Ti.

7. A method of forming an alloy object, comprising:
spraying the alloy casting material as claimed in claim 1 by inert gas to form powders;
melting the powders by laser additive-manufacturing to form a melted object; and
processing an ageing heat treatment for the melted object to complete the alloy object.

8. The method as claimed in claim 7, wherein the powders of the alloy casting material have a diameter of 5 μm to 35 μm.

9. The method as claimed in claim 7, wherein the step of melting the powders by laser-additive manufacturing is performed at a temperature of 660° C. to 2400° C. .

10. The method as claimed in claim 7, wherein the ageing heat treatment is performed at a temperature of 150° C. to 180° C. .
